(19) United States
(12) Patent Application Publication
(10) Pub. No.: US 2016/0250812 A1
(43) Pub. Date: Sep. 1, 2016

(54) AUTOMATED LAMINATE COMPOSITE SOLID PLY GENERATION

(71) Applicant: UNITED TECHNOLOGIES CORPORATION, Hartford, CT (US)

(72) Inventors: James T. Roach, Vernon, CT (US); Ammon Hepworth, Provo, UT (US); Hoyt Y. Chang, Manchester, CT (US); Blake J. Luczak, Pittsburgh, PA (US)

(21) Appl. No.: 15/028,557

(22) PCT Filed: Oct. 1, 2014
(86) PCT No.: PCT/US14/58560

§ 371 Date: Apr. 11, 2016

Related U.S. Application Data
(60) Provisional application No. 61/890,459, filed on Oct. 14, 2013.

(51) Int. Cl. B29C 70/38; B29D 99/00; B29C 70/34

(52) U.S. Cl. CPC B29C 70/386; B29C 70/345; B29D 99/0025; B29C 70/48

(57) ABSTRACT

A method for creating a laminate design geometry for a composite component according to an exemplary aspect of the present disclosure includes, among other things, defining a spatial volume of a solid defined between a plurality of external surface boundaries, defining an offset boundary spaced by an offset value from one of the plurality of external surface boundaries to define a region in which a ply is to be received, defining a partitioning boundary dividing the region into a ply portion and a resin portion; and repeating the steps of defining an offset boundary and defining a partitioning boundary by defining an offset boundary from any one of the plurality of external surface boundaries and the offset boundary in a previous iteration of defining an offset boundary.

### CROSS-REFERENCE TO RELATED APPLICATION

This application claims priority to U.S. Provisional Application No. 61/890,459, filed Oct. 14, 2013.

### BACKGROUND

This disclosure relates to a method of generating a solid geometry for a composite laminate.

Typically, components built from laminate composites are manufactured by laying up several layers of fibrous materials, commonly referred to as lamina and/or plies, to define a three-dimensional geometry.

One method of designing laminate composite component geometry includes determining boundary points for the component. A user defines lamina mid-surface dimensions. Mid-surfaces are used to determine both the number and thicknesses of lamina necessary to build the component. The user then determines boundaries for each lamina depending on a desired finished shape, creates parameters for that defined shape and specifies the orientation for each ply when applied to the composite body. Typically, the user determines if the design is acceptable through a number of iterations, which may be performed automatically, manually, or by some combination of automatic and manual techniques.

### SUMMARY

A method for creating a laminate design geometry for a composite component according to the present disclosure includes a) defining a spatial volume of a solid defined between a plurality of external surface boundaries, b) defining an offset boundary spaced by an offset value from one of the plurality of external surface boundaries to define a region in which a ply is to be received, c) defining a partitioning boundary dividing the region into a ply portion and a resin portion and repeating steps b) and c) by defining an offset boundary from any one of the plurality of external surface boundaries and the offset boundary in a previous iteration of step b).

In a further embodiment of the foregoing embodiment, a number of iterations of step d) is based upon a distance between each region defined in step b) being less than the offset value.

In a further embodiment of any of the foregoing embodiments, the ply portion is represented by a first material and the resin portion is represented by a second material different from the first material.

In a further embodiment of any of the foregoing embodiments, the offset value is a thickness of the ply.

In a further embodiment of any of the foregoing embodiments, a cross section of the spatial volume is defined by at least three external surface boundaries.

In a further embodiment of any of the foregoing embodiments, each of the external surface boundaries extends between two inflection points at a cross section of the spatial volume.

In a further embodiment of any of the foregoing embodiments, the partition boundary perpendicularly intersects the offset boundary at an intersection of the respective offset boundary and one of the plurality of external surface boundaries or another offset boundary.

In a further embodiment of any of the foregoing embodiments, the method further comprises accessing a ply table defining at least one ply attribute.

In a further embodiment of any of the foregoing embodiments, the method further comprises laying up a plurality of plies of a laminate according to the laminate design geometry.

In a further embodiment of any of the foregoing embodiments, the method further comprises defining a mid-surface boundary extending from the partitioning boundary, wherein a length of the ply corresponds to the mid-surface boundary.

A method for fabricating a composite component according to a laminate design geometry according to the present disclosure includes laying up a plurality of plies of a laminate according to a predetermined laminate design geometry. The predetermined laminate design geometry includes data representing a plurality of regions in which a ply of the plurality of plies is to be received. Each of the regions is defined by an offset boundary spaced by an offset value from an external surface boundary or another offset boundary, and each of the regions is divided into a ply portion and a resin portion by a partition boundary.

In a further embodiment of any of the foregoing embodiments, the method further comprises injecting an amount of resin in the resin portion.

In a further embodiment of any of the foregoing embodiments, the method further comprises generating a data set representing the predetermined laminate design geometry.

A composite component according to an example of the present disclosure includes a plurality of plies and a resin arranged according to a predetermined laminate design geometry. The predetermined laminate design geometry includes data representing a plurality of regions in which a ply of the plurality of plies is to be received. Each of the regions is defined by an offset boundary spaced by an offset value from an external surface boundary or another offset boundary, and each of the regions is divided into a ply portion and a resin portion by a partition boundary.

In a further embodiment of any of the foregoing embodiments, the ply portion is a first material and the resin portion is a second material different from the first material.

In a further embodiment of any of the foregoing embodiments, the first material includes a composite structure and the second material includes a resin.

In a further embodiment of any of the foregoing embodiments, the offset value is a thickness of the ply.

In a further embodiment of any of the foregoing embodiments, a cross section of the predetermined laminate design geometry is defined by at least three external surface boundaries.

In a further embodiment of any of the foregoing embodiments, composite component further comprises an overwrap extending from at least two of the regions.

In a further embodiment of any of the foregoing embodiments, the predetermined laminate design geometry represents an airfoil.

These and other features disclosed herein can be best understood from the following specification and drawings, the following of which is a brief description.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1A shows a sample composite component including a single ply.

FIG. 1B shows the composite component of FIG. 1A including a plurality of plies.

FIG. 2 shows a process of creating laminate design geometry.

FIG. 3 shows a process of fabricating a composite component.

### DETAILED DESCRIPTION

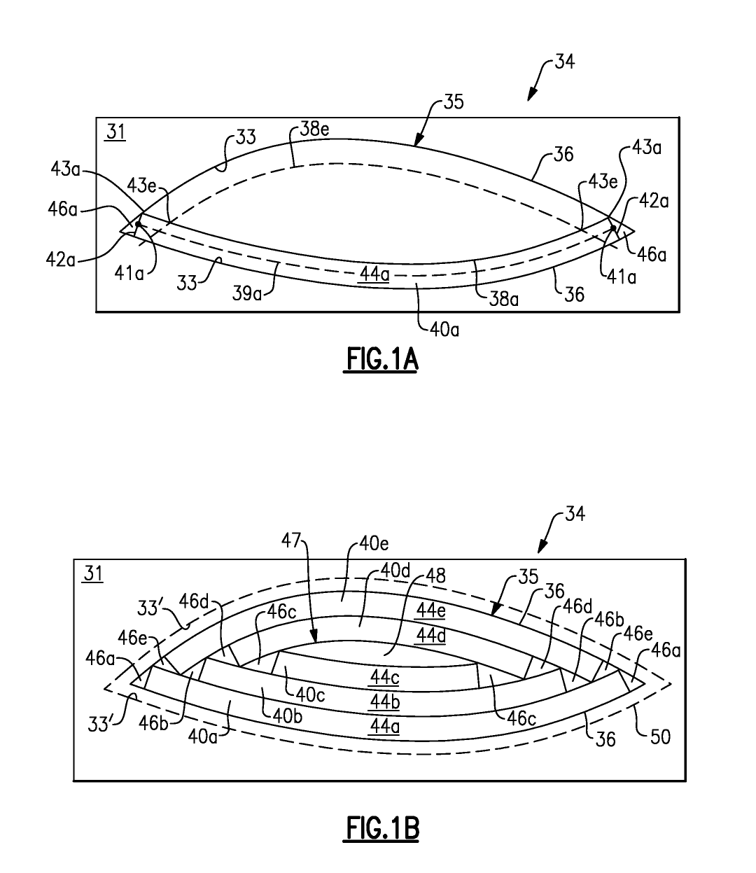

FIGS. 1A and 1B illustrate one example of a composite component. In this example, the composite component includes an elliptical cross section. However, it is to be understood that other types of components and geometries can benefit from the examples disclosed herein which are not limited to the design shown. Component examples include structural guide vanes and nacelle sections of a turbine engine, other aerospace applications, and various conventional composite components including complex topographies.

A cross-section of a solid 34 inserted into a mold 31 having surfaces 33 is shown, the solid 34 being the laminate composite component. The solid 34 defines a spatial volume 35 defined between a plurality of external surface boundaries 36. In one example, the external surface boundaries 36 are a pressure side and a suction side of an airfoil. In another example, the external surface boundaries 36 are a tip and a root of the airfoil, or any other surfaces of a composite component. The spatial volume 35 includes a plurality of regions 40 in which a ply of a plurality of plies is to be received. Each of the regions 40 is defined by an offset boundary 38. The offset boundary 38 is spaced by an offset value from a surface boundary. In some examples, the offset value is a thickness of each ply. The surface boundary can be one of the external surface boundaries 36 or another offset boundary 38. It should be understood that FIGS. 1A and 1B illustrate just one cross section of the composite component through two external surface boundaries 36. However, the composite component can include offset boundaries from other external surface boundaries of the composite component.

Each of the regions 40 is divided into a ply portion 44 and a resin portion 46 by a partition boundary 42. In some examples, the partition boundary 42 extends from an intersection 43 between the offset boundary 38 and another one of the external surface boundaries 36 or another offset boundary 38. In some examples, the ply portion 44 is represented by a first material and the resin portion 46 is represented by a second material different from the first material. For example, the first material includes a composite structure made of unidirectional fibers or fabric, and the second material includes a resin such as polyurethane. In some examples, the resin portion 46 does not include any fibers. In other examples, the first and second materials differ in density. In yet other examples, the ply portion 44 and resin portion 46 include fibers arranged at different orientations.

The spatial volume 35 can include one or more secondary volumes 47 defined at various locations within the spatial volume 35. The secondary volumes 47 can include either of the first and second materials, or another, different material. Further, each of the secondary volumes 47 can include the same material or a different material as each of the other secondary volumes 47. Additionally, each of the secondary volumes 47 can be defined by one or more regions 40 as previously disclosed. In another example, one of the secondary volumes 47 is a core volume 48 positioned within the spatial volume 35 (shown in FIG. 1B). In some examples, the core volume 48 is positioned at a predetermined location within the spatial volume 35. In other examples, the core volume 48 is defined as a portion of the spatial volume 35 remaining between the regions 40 once the regions 40 are defined. In one example, the core volume 48 includes the same material as the resin portions 46.

In other examples, the solid 34 includes an overwrap volume 50 for receiving an overwrap. The overwrap volume 50 extends from and surrounds at least a portion of at least two of the regions 40 (shown in FIG. 1B). In some examples, the overwrap includes a fabric. However, other configurations of the overwrap are contemplated.

In some examples, a mid-surface boundary 39 (shown in FIG. 1A) extends a length of the ply portion 44 between a pair of bias points 41 located on the partition boundaries 42. In some examples, the mid-surface boundary 39 is spaced between the offset boundary 38 and another offset boundary 38 or one of the external surface boundaries 36 defining the region 40. In another example, the mid-surface boundary 39 is positioned relatively closer to one of the offset boundaries 38 or external surface boundaries 36. In a further example, the offset boundary 38 or one of the external surface boundaries 36 defines the mid-surface boundary 39.

The mid-surface boundary 39 defines a ply length corresponding to a length of a ply to be received within the ply portion 44 prior to the ply being positioned within the ply portion 44. For example, the ply can include a substantially planar profile prior to being laid up, and can include a non-planar or arcuate profile when positioned within the ply portion 44. Data corresponding to the ply length defined by the mid-surface boundary 39 can be used to determine a desired position to cut or trim the ply during a trimming process.

In some examples, the partition boundary 42 is normal or perpendicular to the offset boundary 38. The mid-surface boundary 39 and bias points 41 can be spaced an equal distance between the external surface boundary 36 or offset boundary 38 and another offset boundary 38 defining the region 40. In this arrangement, the length of the ply portion 44 can be substantially equal along the offset boundary 38 and the external surface boundary 36 or another offset boundary 38. The configuration of the ply dimensioned during the trimming process can conform to the dimension of the ply portion 44, such as when the cutting angle of the ply is substantially perpendicular.

In instances where the partition boundary 42 is oblique to the offset boundary 38, it may be desirable to define the ply length based upon one of the external surface boundaries 36 or offset boundary 38 defining the ply portion 44, particularly where the angle of the partition boundary 42 is not equal to a cutting angle of the ply during the trimming process. Because the volume of the ply portion 44 depends on the position of the partition boundary 42, the mid-surface boundary 39 and bias points 41 can be positioned or biased more closely to one of the external surface boundaries 36 or offset boundary 38 defining the region 40 to address various design and manufacturing considerations. Some considerations can include the risk of bunching due to portions of the ply being longer than the ply portion 44 when the ply is received within the ply portion 44 during the fabrication process, the desired volume of the resin portion 46, and error or tolerances in the manufacturing process.

In other examples, each of the regions 40 includes only a ply portion 44 and omits each resin portion 46. The partition boundary 42 can extend between an end of the offset boundary 38 and an end of another offset boundary 38 or external surface boundary 36 defining the region 40. The mid-surface boundary 39 is truncated within the region 40 The mid-surface boundary 39 can be spaced from the offset boundaries 38 by a bias quantity to address various design and manufacturing considerations discussed herein.

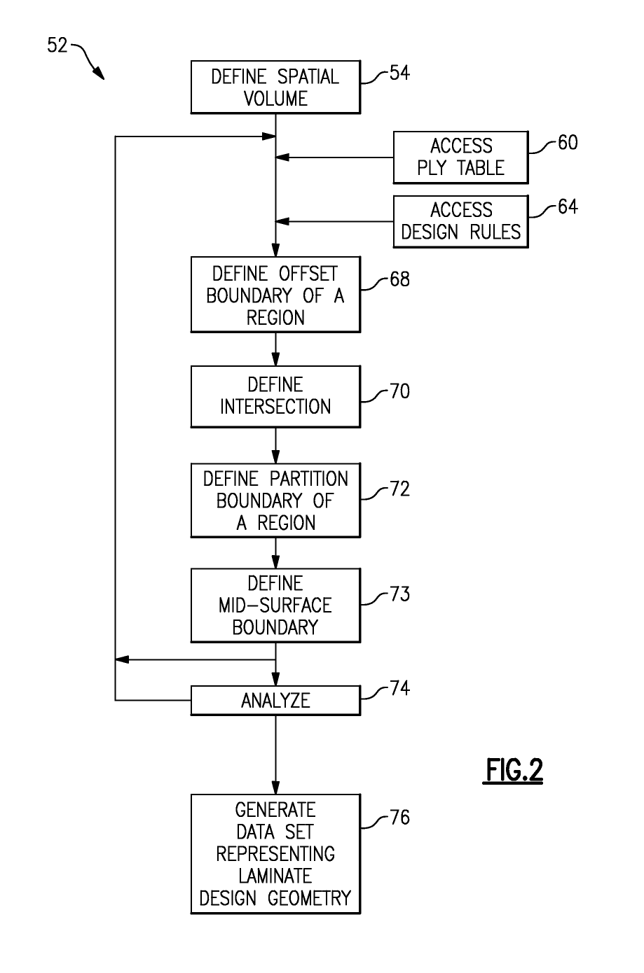

FIG. 2 illustrates a method 52 for creating laminate design geometry for a composite component, such as the solid 34 shown in FIGS. 1A-1B. The user inputs into a computer (not shown) data corresponding to the spatial volume 35 of the solid 34 defined between the pluralities of external surface boundaries 36 according to X, Y, Z point protocols at step 54. In some examples, a cross section of the spatial volume 35 is defined by at least three external surface boundaries. In other examples, each of the external surface boundaries extends between two inflection points at a cross section of the spatial volume. In further examples, the core volume 48 is defined within the spatial volume 35. In other examples, an overwrap volume 50 is defined within, or extending from, the spatial volume and represents the overwrap.

In some examples, a ply table is accessed at step 60. The ply table can be organized as a data set and includes at least one ply attribute corresponding to each ply or ply portion. Various ply attributes are contemplated, including a type of ply material (e.g., para-aramid synthetic fiber, graphite, fiberglass, etc.) and its characteristics, whether the ply is a pre-form, ply thickness, ply orientation relative to other plies, ply density, ply material cost, the type of weave of the ply, stacking thickness, ply sequencing, etc. In some examples, the ply attribute is a priority value designating the priority of a given ply portion in the arrangement of the composite component. In other examples, a trimming geometry based upon the priority of the ply can be utilized to determine whether one or more ends of the ply are trimmed by a relatively higher priority ply. In further examples, the ply table includes a bias quantity for the mid-surface boundary 39.

In further examples, one or more design rules are accessed at step 64. In some examples, the rules include a predetermined arrangement for stacking the plies, such as from external surfaces towards the middle of the composite component, building or wrapping around a complex shape such as the core volume 48, or alternating the plies between each side of the composite component. In other examples, a user may choose to have the computer determine any one or any combination of the ways to stack plies in designing the composite component. Other example rules include a ply drop-off ratio, a ratio of the resin portion 46 and the ply portion 44 of each region 40, and a maximum bend radius of the ply portion 44. It should also be appreciated that the design rules can be represented within the ply table.

The ply attributes and design rules can be used to predict future applicability of those arrangements in other designs. Also, by organizing this information into the ply attributes and design rules, a designer has ready access to the information in order to make rapid design decisions and can load these parameters quickly for creating laminate design geometry.

In a first iteration of the method 52, the offset boundary 38 for the first one of the regions 40 is defined at step 68. The offset boundary 38 is spaced by an offset value from one of the external surface boundaries 36 to define the region 40 in which a ply is to be received. In some examples, the offset value is a thickness of the ply received in the region 40. At least one intersection 43 is defined along the offset boundary 38 at one of the external surface boundaries 36 at step 70. The partition boundary 42 is defined at step 72, dividing the region 40 into the ply portion 44 and the resin portion 46. In some examples, the partition boundary 42 perpendicularly intersects the offset boundary 38 at the intersection 43 of the respective offset boundary 38 and one of the external surface boundaries 36 or another offset boundary 38 (shown in FIGS. 1A-1B). In other examples, the partition boundary 42 is oblique to the offset boundary 38 at the intersection 43. In yet other examples, the partition boundary is based upon a distance from the surface of the external surface boundaries 36 or offset boundary 38 bounding the region 40. It should also be appreciated that each of the regions 40 can include sub-regions, each including one or more ply portions 44 and resin portions 46. A mid-surface boundary 39 is defined at step 73. In other examples, each mid-surface boundary 39 is defined after analysis is performed at step 74, as described below.

The steps 68 and 72 are repeated by defining an offset boundary 38 from any one the external surface boundaries 36 or the offset boundary 38 in a previous iteration of defining the offset boundary at step 68. In some examples, the number of iterations of steps 68 and 72 is based upon a distance between each of regions 40 defined in step 68 being less than the offset value. In further examples, iterations are performed in an alternating stack sequence (shown in FIGS. 1A and 1B). In other examples, each offset boundary 38 is defined from the previous iteration of the offset boundary 38 defined at step 68 (i.e., stacked from one side of the spatial volume 35).

In examples including one or more secondary volumes 47, the previous steps can be utilized to define ply portions 44, resin portions 46, and partition boundaries 42 for each of the secondary volumes 47. In further examples, each of the secondary volumes 47 can include the same ply table and design rules as the spatial volume 35 or a different ply table and set of design rules.

Thereafter, an analysis of the design of the spatial volume 35 is conducted at step 74. If the spatial volume 35 conforms to design requirements and user objectives for the composite component, a data set is generated representing laminate design geometry of the solid 34 at step 76. Otherwise, the process for creating laminate design geometry is reinitiated until the spatial volume 35 conforms to design requirements and user objectives. Analysis can include “draping” as is known in the art, in which the CAD surface data or a portion of the data set including point and contour line data within a sheet body definition is compared to ply manufacturing feasibility. The sheet body definition corresponds to a planar representation of each of the regions 40 and/or ply portions 44 and is derived from the volume and sheet data for the regions 40 and/or ply portions 44, each mid-surface boundary 39, and external surface boundaries 36 and offset boundaries 38.

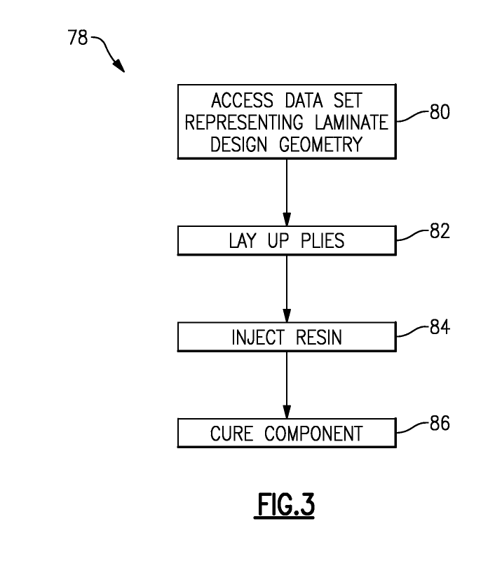

FIG. 3 illustrates a method 78 for fabricating a composite component, such as the solid 34 shown in FIGS. 1A-1B. However, it should be appreciated that other composite components can be fabricated according to the method 78, including two-dimensional designs, three-dimensional designs, and other laminate composite components having complex topologies. The method 78 begins at step 80, where a data set representing laminate design geometry is accessed. In some examples, the data set is generated from the method 52 for creating laminate design geometry for the solid 34 shown in FIG. 1B. At step 82, a plurality of plies are placed the mold 31 and laid up in each of the ply portions 44. At step 80, resin is injected into each of the resin portions 46. In some examples, at least some of the plies are pre-impregnated with a resin material. Together, the ply portions 44 and resin portions 46 define the regions 40. The components located within the mold 31 are cured in an oven, autoclave or by other conventional methods to define the composite component.

The method of generating a solid geometry of a laminate composite component includes many benefits over conventional approaches. One benefit includes generating a solid geometry rather than a conventional mid-surface representation of each ply, thus reducing error in characterizing certain structural aspects of the composite component. Another benefit of the method is that a solid geometry can be rapidly generated for complex three-dimensional topologies such as T-intersections and contoured surfaces. This allows the designer to rapidly visualize the ply geometry before the composite component is fabricated, thus ensuring that the solid geometry meets design requirements and user objectives. In instances where a mid-surface boundary is defined, a ply length defined by the mid-surface boundary can be used to determine suitable ply geometries. Another benefit is that the solid geometry can be used to generate manufacturing data, thereby streamlining the product definition during the manufacturing process. The data set representing the solid geometry can be provided to another process or application for post-processing and analysis, such as Finite Element Analysis (FEA), where a FEA mesh can be used to evaluate the structural characteristics of the composite component.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed:

1. Method for creating a laminate design geometry for a composite component, the method comprising:
a) defining a spatial volume of a solid defined between a plurality of external surface boundaries;
b) defining an offset boundary spaced by an offset value from one of said plurality of external surface boundaries to define a region in which a ply is to be received;
c) defining a partitioning boundary dividing said region into a ply portion and a resin portion; and
d) repeating steps b) and c) by defining an offset boundary from any one of said plurality of external surface boundaries and said offset boundary in a previous iteration of step b).

2. The method of claim 1, wherein a number of iterations of step d) is based upon a distance between each said region defined in step b) being less than said offset value.

3. The method of claim 1, wherein said ply portion is represented by a first material and said resin portion is represented by a second material different from said first material.

4. The method of claim 1, wherein said offset value is a thickness of said ply.

5. The method of claim 1, wherein a cross section of said spatial volume is defined by at least three external surface boundaries.

6. The method of claim 1, wherein each of said external surface boundaries extends between two inflection points at a cross section of said spatial volume.

7. The method of claim 1, wherein said partition boundary perpendicularly intersects said offset boundary at an intersection of the respective offset boundary and one of said plurality of external surface boundaries or another offset boundary.

8. The method of claim 1, further comprising accessing a ply table defining at least one ply attribute.

9. The method of claim 1, further comprising laying up a plurality of plies of a laminate according to said laminate design geometry.

10. The method of claim 1, further comprising defining a mid-surface boundary extending from said partitioning boundary, wherein a length of said ply corresponds to said mid-surface boundary.

11. Method for fabricating a composite component according to a laminate design geometry, the method comprising:
laying up a plurality of plies of a laminate according to a predetermined laminate design geometry,
wherein said predetermined laminate design geometry includes data representing a plurality of regions in which a ply of said plurality of plies is to be received, each of said regions being defined by an offset boundary spaced by an offset value from an external surface boundary or another offset boundary, and each of said regions being divided into a ply portion and a resin portion by a partition boundary.

12. The method of claim 11, further comprising injecting an amount of resin in said resin portion.

13. The method of claim 11, further comprising generating a data set representing said predetermined laminate design geometry.

14. A composite component, comprising:
a plurality of plies and a resin arranged according to a predetermined laminate design geometry,
wherein said predetermined laminate design geometry includes data representing a plurality of regions in which a ply of said plurality of plies is to be received, each of said regions being defined by an offset boundary spaced by an offset value from an external surface boundary or another offset boundary, and each of said regions being divided into a ply portion and a resin portion by a partition boundary.

15. The composite component of claim 14, wherein said ply portion is a first material and said resin portion is a second material different from said first material.

16. The composite component of claim 15, wherein said first material includes a composite structure and said second material includes a resin.

17. The composite component of claim 14, wherein said offset value is a thickness of said ply.

18. The composite component of claim 14, wherein a cross section of said predetermined laminate design geometry is defined by at least three external surface boundaries.

19. The composite component of claim 14, further comprising an overwrap extending from at least two of said regions.

20. The composite component of claim 14, wherein said predetermined laminate design geometry represents an airfoil.
